(19) United States
(12) Patent Application Publication
(10) Pub. No.: US 2008/0104368 A1
(43) Pub. Date: May 1, 2008

(54) Storage element having data protection functionality

(75) Inventor: Eiji Hasegawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/703,220

(22) Filed: Feb. 7, 2007

(30) Foreign Application Priority Data
Oct. 27, 2006 (JP) 2006-292796

(51) Int. Cl. G06F 15/76

(52) U.S. Cl. 712/14

(57) ABSTRACT

A storage element has data protection functionality for receiving a data-writing and a data-reading from a functional module. The storage element comprises a storage unit that has a memory region with a predetermined capacity for storing the data and stores the data written by the functional module, a data amount management register that stores an amount of the data written by the functional module so as to be readable from the functional module and a control unit that controls, when the data stored in the storage unit is read by the functional module, to disable a data-reading from a portion of the memory region of the storage unit where data corresponding to the read data is stored, until a data-writing is performed by the functional module.

### CROSS-REFERENCE TO RELATED APPLICATION

This application is related to Japanese patent application No. 2006-292796 filed on Oct. 27, 2006 whose priority is claimed under 35 USC §119, the disclosure of which is incorporated by reference in its entirety.

### BACKGROUND OF THE INVENTION

1. Field of the Invention

The present invention relates to a storage element having data protection functionality. More particularly, the present invention relates to a storage element having data protection functionality used in an information processing apparatus that records and plays back contents requiring copyright protection.

2. Description of the Related Art

In recent years, the number of cases where an information device handles contents protected in various ways has been increased.

However, since a contents protection method and a contents encoding method vary depending on standards, there is an increasing number of cases where software modules handling contents created by different standards are separately developed and data is exchanged between these modules.

Such a software module handling contents data with contents protection is generally designed to be tamper-resistant to prevent protected data from being stolen or tampered by an unauthorized attack. For designing software to be tamper-resistant, various techniques, such as instruction code obfuscation, debugger detection, and program tamper detection, are developed.

FIG. 16 is a conceptual illustrative diagram showing modules designed to be tamper-resistant by a conventional method.

Since a direct attack on such tamper-resistant modules (A and B) is almost impossible, it is difficult to steal contents data present in the modules by an unauthorized attack.

However, when a plurality of such software modules are prepared and data is mutually exchanged between the modules, interfaces which an OS releases to the public are used. The interfaces are a socket, a shared memory, and file mapping, and so on. FIG. 17 is a conceptual illustrative diagram showing a case where data is mutually exchanged between such modules.

A general interface portion connecting two modules is easily attacked and thus data is relatively easily stolen.

Hence, when the protected data is exchanged between the modules, tamper detection by encryption or hashing is generally performed to prevent the protected data from being peeked or tampered during the data exchange.

For example, Japanese Unexamined Patent Publication No. HEI 11(1999)-88859 describes a data protection apparatus in which a receiving module for receiving data performs encryption, and after the data passes through a bus a processing module performs a decryption process.

FIG. 18 is a conceptual illustrative diagram showing a case of transferring the protected data from a contents providing program unit (module A) to a contents display program unit (module B). The protected data is subject to an encryption process in the module A and then the encrypted data is passed to the module B. Data on a way to pass through a general interface is encrypted in a format that is known only by the tamper-resistant modules A and B. The module B decrypts the received data to use the decrypted data.

Although it is not shown, the tamper detection may be performed by performing the hashing process or the like in addition to the encryption. Such an encryption/tamper detection process performed to prevent data from being stolen by an unauthorized attacker is hereinafter called as a data protection process. By performing such a data protection process, even if an unauthorized attack module peeks midway data, the unauthorized attack module cannot obtain useful information.

To implement a mechanism of FIG. 18, various mounting methods for a socket and the like are used.

When the data is passed within a local machine, as shown in FIG. 19, the data is written once into a memory or a hard disk HDD located outside the module.

In conventional methods such as described above, however, if the size of the protected data to be passed increases, workload for the encryption and decryption processes and the hashing process increases, causing a problem that the processes require a long period of time.

Particularly, when the data is exchanged between software-configured modules in an information device such as a personal computer, there is a need to perform encryption in one of the modules before transmission and to perform decryption in the other module after reception. Thus, a CPU is used to perform the both processes and accordingly an increase in processing load becomes a non-negligible amount.

A method may be considered in which instead of individually designing modules A and B to be tamper-resistant, an entire system is designed to be tamper-resistant to prevent the unauthorized attack. However, designing the entire system to be tamper-resistant increases difficulty in system development, resulting in increases in system development costs and apparatus costs.

Accordingly, development of a security system is desired in which, while an increase in costs is suppressed as much as possible without designing the entire system to be tamper-resistant, the load of the data protection process is also reduced as much as possible.

### SUMMARY OF THE INVENTION

The present invention provides a storage element for receiving a data-writing and a data-reading from a functional module, the storage element including: a storage unit that has a memory region with a predetermined capacity for storing the data and stores the data written by the functional module; a data amount management register that stores an amount of the data written by the functional module so as to be readable from the functional module; and a control unit that controls, when the data stored in the storage unit is read by the functional module, to disable a data-reading from a portion of the memory region of the storage unit where data corresponding to the read data is stored, until a data-writing is performed by the functional module.

According to the invention, since there is no need to perform complex and time-consuming processes, such as encryption and decryption processes, to prevent data from leaking by an unauthorized access, the load of processing for data protection can be suppressed while sufficient security is ensured. That is, when data is transferred between two modules, the time and load necessary for processing which is performed to ensure the security of the transferred data can be reduced.

Here, the read data indicates data to be outputted from the storage element according to the present invention. Data corresponding to the read data indicates data being held in the memory region included in the storage element according to the present invention. A portion of the memory region where data corresponding to the read data is stored indicates, for example, a region on the memory region where the data is held or had been held that is identified by predetermined address and data length. The expression “to disable a data-reading” indicates that in response to a read operation of a functional module, a storage element does not output data having the same contents as data written into the storage element. For example, a component is included that outputs a non-allowance response to a read operation or outputs data having different contents from written data.

### BRIEF DESCRIPTION OF THE DRAWINGS

FIG. 1 is a schematic illustrative diagram of a data protection mechanism according to the present invention;

FIG. 2 is an illustrative diagram showing a case where there is an unauthorized access in the data protection mechanism according to the present invention;

FIG. 3 is an illustrative diagram showing another case where there is an unauthorized access in the data protection mechanism according to the present invention;

FIG. 4 is a configuration block diagram of an information processing apparatus implementing data transfer functionality and the like according to one embodiment of the present invention;

FIG. 5 is an illustrative diagram of a recording block and the like of a secure memory unit according to the present invention;

FIG. 6 is an illustrative diagram of a correspondence between an access control flag and a read-once region according to the present invention;

FIG. 7 is a flowchart of a read process performed on the read-once region of the secure memory unit according to the present invention;

FIG. 8 is a flowchart of a write process performed on a write-only region of the secure memory unit according to the present invention;

FIGS. 9A and 9B are illustrative diagrams of processing contents by a transfer processing unit of the secure memory unit according to the one embodiment of the present invention;

FIG. 10 is an illustrative diagram of management information used upon a data transfer according to the one embodiment of the present invention;

FIG. 11 is a flowchart of a contents providing program unit (module A) according to the one embodiment of the present invention;

FIG. 12 is a flowchart of a contents display program unit (module B) according to the one embodiment of the present invention;

FIG. 13 is a configuration block diagram of the information processing apparatus according to the one embodiment of the present invention;

FIG. 14 is an illustrative diagram of determination of validity of the data transfer according to the one embodiment of the present invention;

FIG. 15 is an illustrative diagram of a verification process of validity of the secure memory unit according to the one embodiment of the present invention;

FIG. 16 is a conceptual illustrative diagram of a conventional tamper-resistant module;

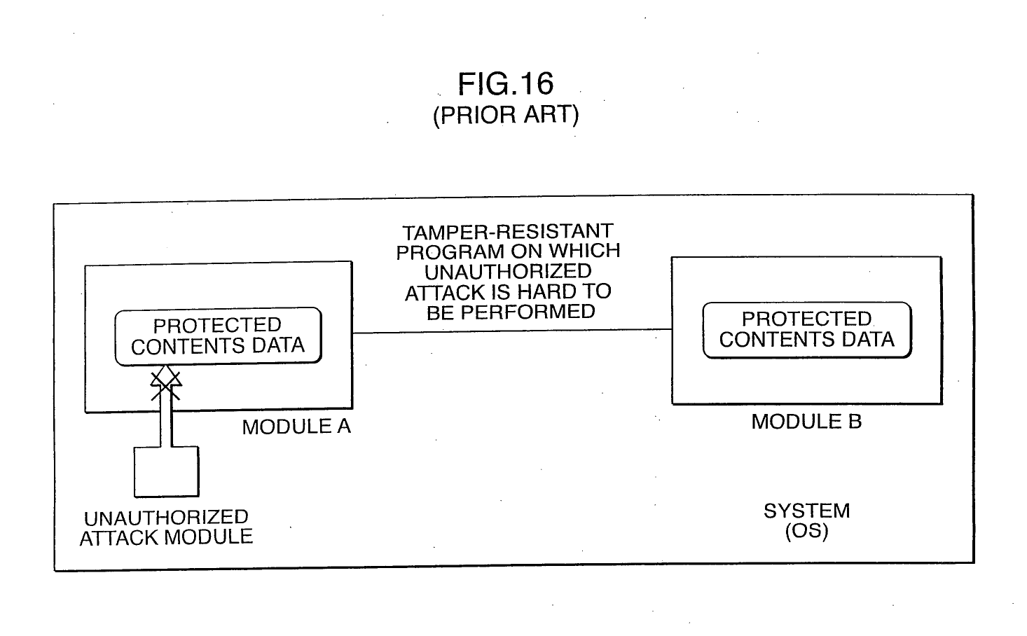

FIG. 17 is a conceptual illustrative diagram showing a conventional case where data is mutually exchanged between two modules;

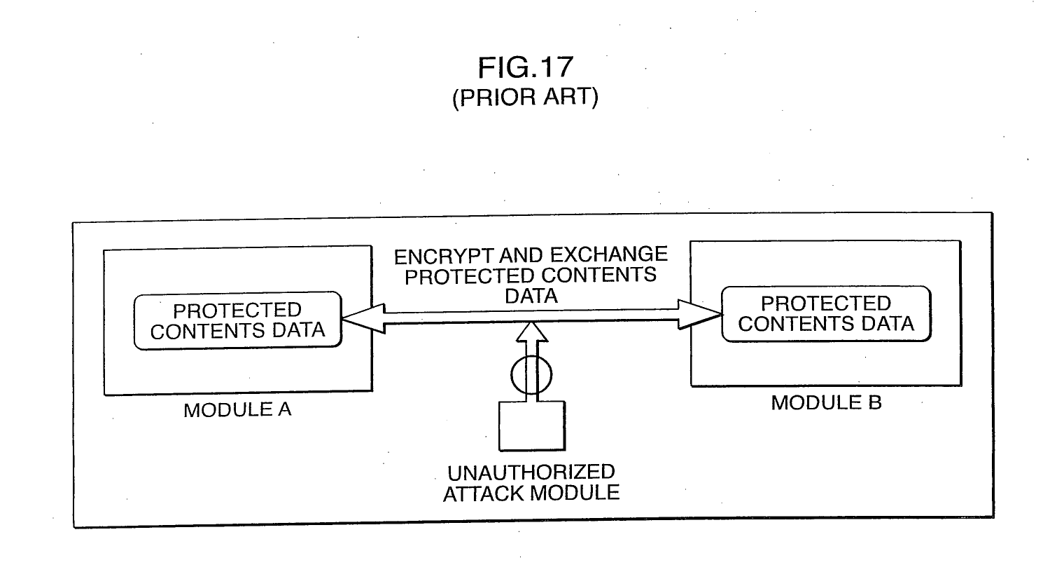

FIG. 18 is a conceptual illustrative diagram showing another conventional case where the data is transferred between the two modules; and

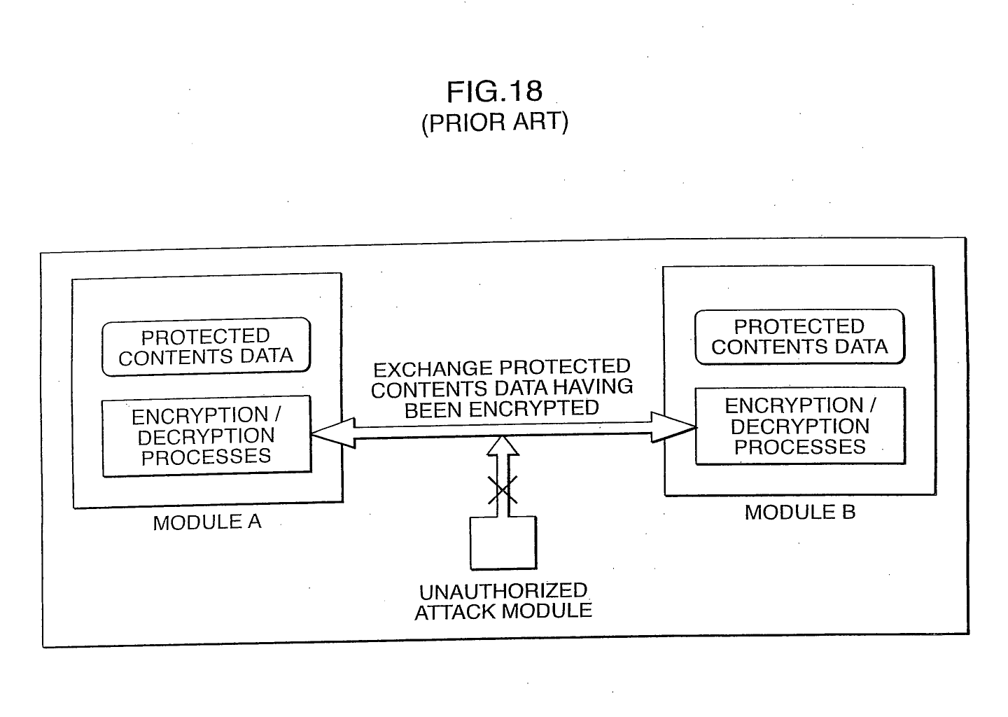

FIG. 19 is a conceptual illustrative diagram showing the conventional case where the data is transferred between the modules using a hard disk.

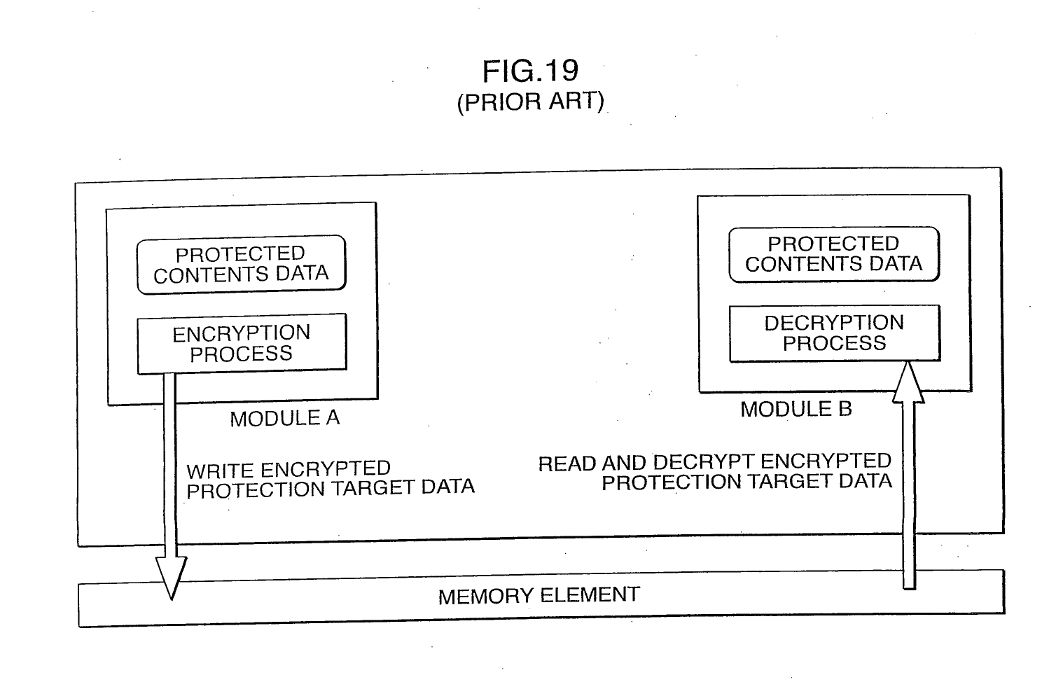

### DESCRIPTION OF THE PREFERRED EMBODIMENTS

The present invention is a storage element in which restrictions are imposed on a write into and a read from the storage element used for data transfer between modules and a mechanism is provided for managing, for example, an amount of data transferred between the modules, whereby when the data is transferred between the modules, load of processing for data protection can be suppressed while sufficient security is ensured.

The storage element according to the present invention further includes an access control flag for allowing or denying an access from the functional module, wherein the control unit allows a writing into the storage unit from the functional module and denies a reading from the storage unit by the functional module when the access control flag is in a first state, denies a writing into the storage unit from the functional module and allows a reading from the storage unit by the functional module when the access control flag is in a second state, denies a writing into the storage unit from the functional module by setting, after the data is written by the functional module, the access control flag to the second state, and allows a reading from the storage unit by the functional module when there is a reading request from the functional module with the access control flag being in the second state, and denies a reading from the storage unit by the functional module by setting, after the reading is performed, the access control flag to the first state.

According to the storage element, data written once into the storage unit can be prevented from being illegally overwritten until the data is read.

Here, the first state is “0”, for example, and the second state is “1”, for example.

Further, the present invention provides a storage element for receiving a data-writing and a data-reading from a functional module, the storage element including: a storage unit including: a write-only memory region that has a memory region with a predetermined capacity for storing the data, stores the data written by the functional module, and allows only a writing of the data; and a read-only memory region that allows only a reading of the data; a transfer processing unit that transfers the data written into the write-only memory region to the read-only memory region; an access control unit that disables a reading from a portion of the read-only memory region where the data read once is stored, until the data is transferred to the read-only memory region from the write-only memory region; and a data amount management register that stores, as an amount of data written by the functional module, an amount of the data transferred by the transfer processing unit so as to be readable from the functional module.

According to the storage element, since data transfer is performed using the write-only memory region and the read-only memory region, sufficient security can be ensured without performing complex and time-consuming processes such as encryption. Accordingly, the load for data protection is suppressed and data leakage and unauthorized use of data by an unauthorized access upon data transfer can be prevented.

In addition, even if the processing speed of the storage element is low relative to the speed of a data-writing from the functional module, the storage element just needs to count an amount of data according to a speed at which data written into the write-only memory region is transferred and thus high-speed processing is not required in the storage element. It is also possible to control such that before a portion of the read-only memory region where data is transferred once is read by the functional module, a writing into the write-only memory region is performed by the functional module.

The storage element according to the present invention further includes an access control flag for allowing or denying an access from the functional module, wherein the access control unit allows a writing into the write-only memory region and denies a reading from the read-only memory region when the access control flag is in a first state, denies a writing into the write-only memory region and allows a reading from the read-only memory region when the access control flag is in a second state, and denies a writing into the write-only memory region by setting, after the data is written by the functional module, the access control flag to the second state.

According to this configuration, it can be guaranteed that data written once by the functional module is not overwritten until the data is read by the functional module. Thus, for example, it is possible to cope with an attack such as overwriting data with bogus data by the unauthorized access.

Further, when there is a read request from the second functional module with the access control flag being in the second state, a reading from the read-only memory region is allowed, and by setting, after the read is performed, the access control flag to the first state, a reading from the read-only memory region is denied.

Further, when there is a read request from the second functional module with the access control flag being in the first state, the data being read-request is replaced with pattern data never appearing in the written data and the pattern data is read by the second functional module.

For the pattern data, all-zero data for example can be used.

Further, the present invention provides an information processing apparatus including: the storage element; a first functional module that writes data into the storage element; and a second functional module that reads the data from the storage element, wherein after the first functional module writes contents data into the storage unit of the storage element, the storage element controls such that the written contents data can be read, and the second functional module reads the contents data stored in the storage unit.

According to the information processing apparatus, when data is transferred from the first functional module to the second functional module, the time and load necessary for processing which is performed to ensure the security of the transferred data can be reduced while sufficient security is ensured.

Further, the present invention provides an information processing apparatus including: the storage element; a first functional module that writes data into the storage element; and a second functional module that reads the data from the storage element, wherein after the first functional module writes contents data into the write-only memory region of the storage element, the storage element transfers the written contents data to the read-only memory region of the storage element, and the second functional modules reads the contents data transferred to the read-only memory region.

In the information processing apparatus according to the present invention, the first functional module includes: a communication amount management unit that manages an amount (D1) of the data written into the storage element; and an unauthorized activity detection unit that detects an unauthorized access being made to the data in the storage element, and the unauthorized activity detection unit of the first functional module obtains an amount (D2) of the data written into the storage element by reading the data amount management register of the storage element, and determines whether the unauthorized access is made to the data by comparing the amount (D1) of data managed by the communication amount management unit with the amount (D2) of data.

According to the information processing apparatus, since the unauthorized access can be detected without performing complex and time-consuming processes, such as encryption, to prevent the unauthorized access, an increase in the speed of data transfer and a reduction in processing load can be achieved.

In the information processing apparatus according to the present invention, when the amount (D2) of data obtained from the data amount management register of the storage element is greater than the amount (D1) of data, the unauthorized activity detection unit of the first functional module determines that there is the unauthorized access and the first functional module does not perform a subsequent data-writing into the storage element.

In the information processing apparatus according to the present invention, the second functional module includes an unauthorized activity detection unit, and when the unauthorized activity detection unit of the second functional module detects that the data read from the storage element is pattern data never appearing in the written data, the unauthorized activity detection unit of the second functional module determines that there is the unauthorized access.

According to the information processing apparatus, without performing complex and time-consuming processes for prevention of the unauthorized access, the unauthorized access can be relatively easily detected.

Further, the second functional module includes an unauthorized activity notification unit that notifies, when the unauthorized activity detection unit of the second functional module determines that there is the unauthorized access, the first functional module that there is the unauthorized access, and the first functional module receiving the notification may not perform a subsequent data-writing into the storage element.

The first functional module and the second functional module of the invention correspond to a program that performs processes, such as obtaining, processing, reproduction, reconstruction, and distribution, on contents. In the following embodiments, for example, a module A corresponds to the first functional module and a module B corresponds to the second functional module. The read-only memory region corresponds to a read-once memory and a read-once memory area.

The present invention will be described in detail below based on embodiments shown in the drawings. It is to be understood that the present invention is not limited to the embodiments.

(Schematic Description of Data Protection Mechanism of the Invention)

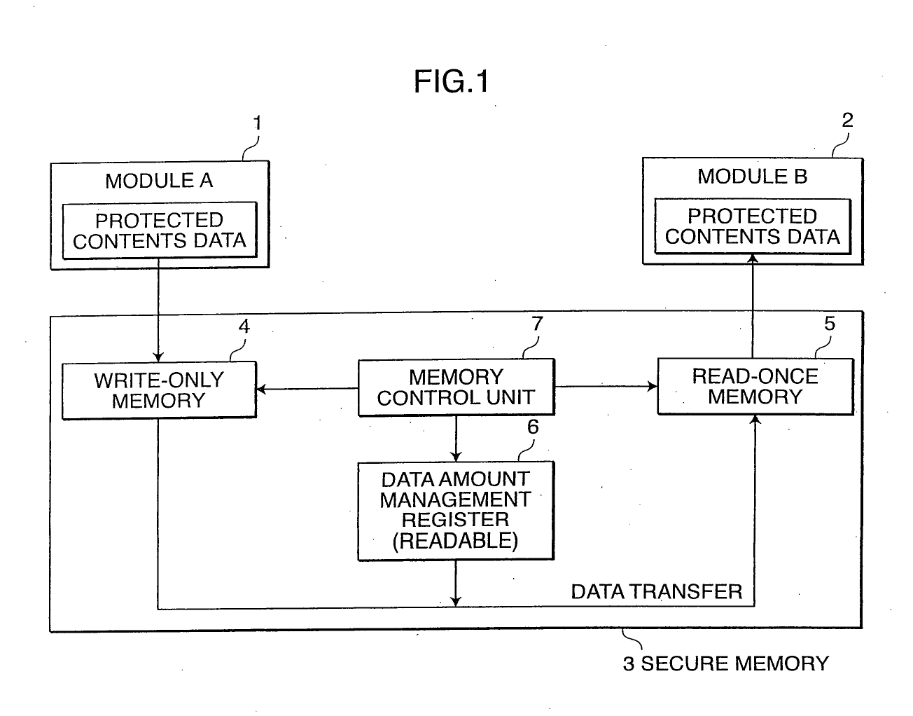

FIG. 1 is an illustrative schematic diagram of a data protection mechanism according to the present invention.

In FIG. 1, a module A (1) and a module B (2) each are a software module that performs processes, such as recording, playback, and display, on contents and are used by being installed under the control of an OS of a personal computer or the like.

A secure memory 3 is composed of rewritable memories (4, 5, and 6) and a memory control unit 7 that manages the access to the memories.

The rewritable memories include a write-only memory 4, a read-once memory 5, and a data amount management register 6. The memories may be provided as separate memories or may be provided by dividing a single memory into three regions and using the three regions as a write-only memory region 4, a read-once memory region 5, and a data amount management register region 6, respectively.

The write-only memory 4 is a memory that can only be written from the viewpoint of the external modules A and B of the secure memory 3 and that has contents that cannot be read from the external module A and the like of the secure memory 3.

The read-once memory 5 is a memory controlled by the memory control unit 7 that manages the access, such that the memory can be read only once from the viewpoint of the external module A and the like of the secure memory 3. In this region, a writing cannot be performed.

Specifically, after a read is performed once, a deny read setting is made and the second and subsequent reads are denied. Control of deny and allow reads is performed using an access control flag 341, as will be described later.

The data amount management register 6 is a memory that stores an amount (e.g., the number of bytes) of data stored in the write-only memory 4 that is transferred to the read-once memory 5. A writing into the register 6 can be performed only by the memory control unit 7. The register 6 is reset when the power is turned on and initialized to zero. The register 6 accumulates and stores amounts of transferred data until being reset. The register 6 is a read-only memory and can only be read from the external modules. Note that the time when a write of contents into the secure memory 3 from the module A or the like starts or the time when a contents transfer process and the like are all completed may be used as an opportunity to reset the register 6.

The present invention is intended to reduce, while ensuring sufficient security when contents data is transferred between the two modules (A and B) such as those shown in FIG. 1, the processing load for preventing an unauthorized attack, such as an attempt to illegally obtain contents, as compared with conventional cases.

The present invention is characterized in that in order to prevent an unauthorized attack the secure memory 3 having the configuration such as the one shown in FIG. 1 is provided and a mechanism for detecting an amount of data transferred through the secure memory 3 is provided.

In conventional cases, when data is transferred from a module A to a module B, after the data is subject to an encryption process in the module A, the encrypted data is written into a general memory such as a RAM and after the module B reads the encrypted data written into the RAM, the encrypted data is subject to a decryption process. But, such encryption and decryption requires a very long period of time and processing loads on a CPU and the like are heavy.

In the present invention, the secure memory 3 is provided to omit the data encryption and decryption processes, whereby the processing load upon transferring data between the modules is reduced.

A general processing sequence for a case of performing a conventional data protection process is as follows:

Data read→data encryption→memory write→memory read→data decryption→data processing.

On the other hand, in the present invention, a processing sequence is as follows:

Data read→memory write→memory read→data processing.

Accordingly, by omitting data encryption and decryption processes, processing is reduced.

Specifically, the following data transfer process is mainly performed.

Here, it is assumed that contents obtained by the module A are transferred to the module B. It is also assumed that the contents are divided into blocks, each having a predetermined amount of data, and are transferred on a block-by-block basis.

First, first block data D11 is written into the write-only memory 4 of the secure memory 3 from the module A without being encrypted. The memory control unit 7 of the secure memory 3 transfers the data D11 written into the write-only memory 4 to the read-once memory 5.

In addition, the memory control unit 7 writes an amount of the transferred data D11 into the data amount management register 6. Thereafter, the module B directly reads the data D11 transferred to the read-once memory 5.

Since the data D11 is not encrypted, the data D11 can be used directly in a state in which the data D11 is captured in the module B.

After the module A has written the data D11 into the write-only memory 4, a read request to the memory 4 cannot be accepted, and thus, even if the unauthorized access (attack) module makes a read request, the data D11 cannot be read from the secure memory 3. That is, the unauthorized access to the data D11 stored in the write-only memory 4 can be prevented.

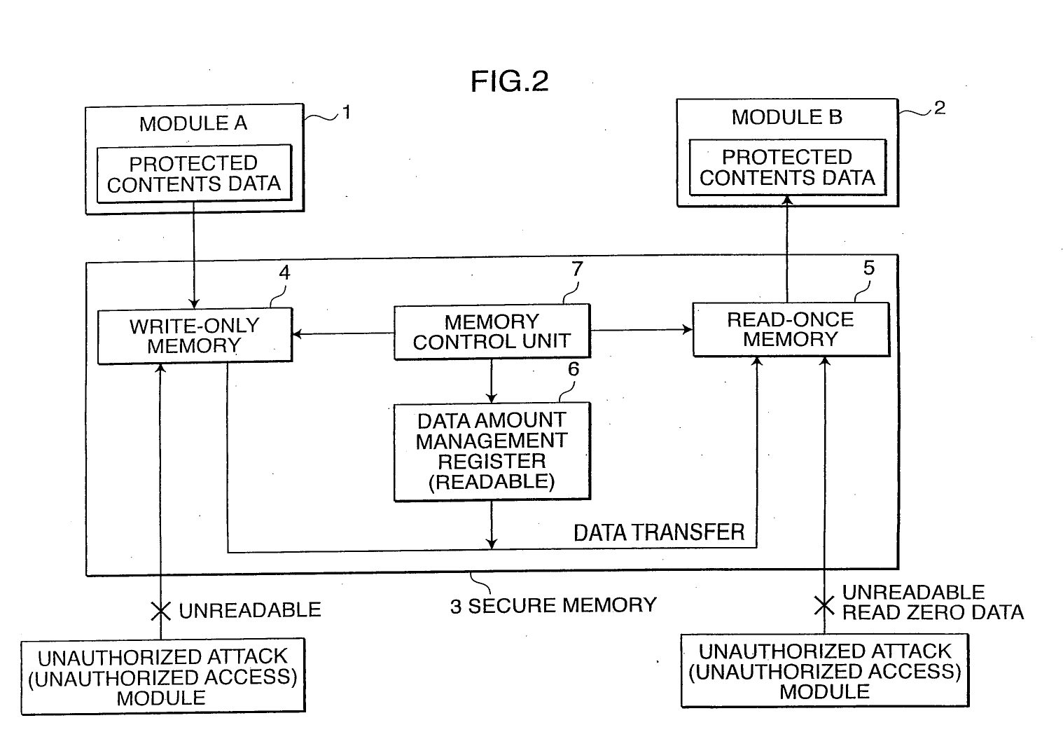

FIG. 2 is an illustrative diagram of the unauthorized access to the secure memory according to one embodiment.

The amount of data D11 written into the memory 4 by the module A is equal to the amount of data transferred to the read-once memory 5 from the write-only memory 4. When the data D11 is the first transferred block, the amount of the data D11 is equal to a numerical value stored in the data amount management register 6.

Therefore, by the module A comparing the amount of the data D11 written thereby with a numerical value stored in the data amount management register 6, it is possible to check whether the data D11 is properly transferred.

Meanwhile, after the module B reads the data D11 in the read-once memory 5, a subsequent reading request to the memory 5 is not allowed. For example, a configuration may be used in which by controlling such that even if the second reading request is made, only pattern data that never appears in written data is read, the reading request cannot be virtually made properly. As the pattern data, for example, all-zero data or all-one data may be used.

Even if, after the properly authenticated module B reads the data D11 from the memory 5, an unauthorized access module provides a read instruction to the read-once memory 5 and attempts to read the data D11 that had transferred to the memory 5, all-zero data is read and the data D11 itself cannot be read.

However, during a period of time after the module A writes data D11 and before the module B reads the data D11 from the read-only memory 5, it is possible for the unauthorized access module to read the data D11 from the read-once memory 5.

That is, the data D11 of one block which is part of contents may be illegally read (see FIG. 2).

However, since, after the unauthorized access module reads the data D11, the authorized module B reads the data D11 that is supposed to be transferred from the module A, when a read instruction is provided to the read-once memory 5, abnormal pattern data, e.g., all-zero data, is read. Specifically, although the module B has read the all-zero data, the module B cannot properly read the data D11.

Hence, if the module B can verify that all-zero data is data that can never present upon normal data read, by the module B checking whether read data is all-zero data, the module B can detect that an unauthorized read is performed (see FIG. 2).

Namely, since an unauthorized read is detected by the module B, control is performed not to perform a subsequent communication process. Specifically, for example, the secure memory 3 is reset and notification that an unauthorized activity is performed is provided to the module A.

By this, even if the first data D11 is illegally read, block data including next second data D12 and subsequent data can be prevented from being illegally read.

When contents composed of a plurality of block data units are transferred, even if the unauthorized access module is involved and one block data is illegally read, subsequent block data can be prevented from being illegally read, and thus, it is possible to prevent the entire contents from illegally leaking and being illegally used.

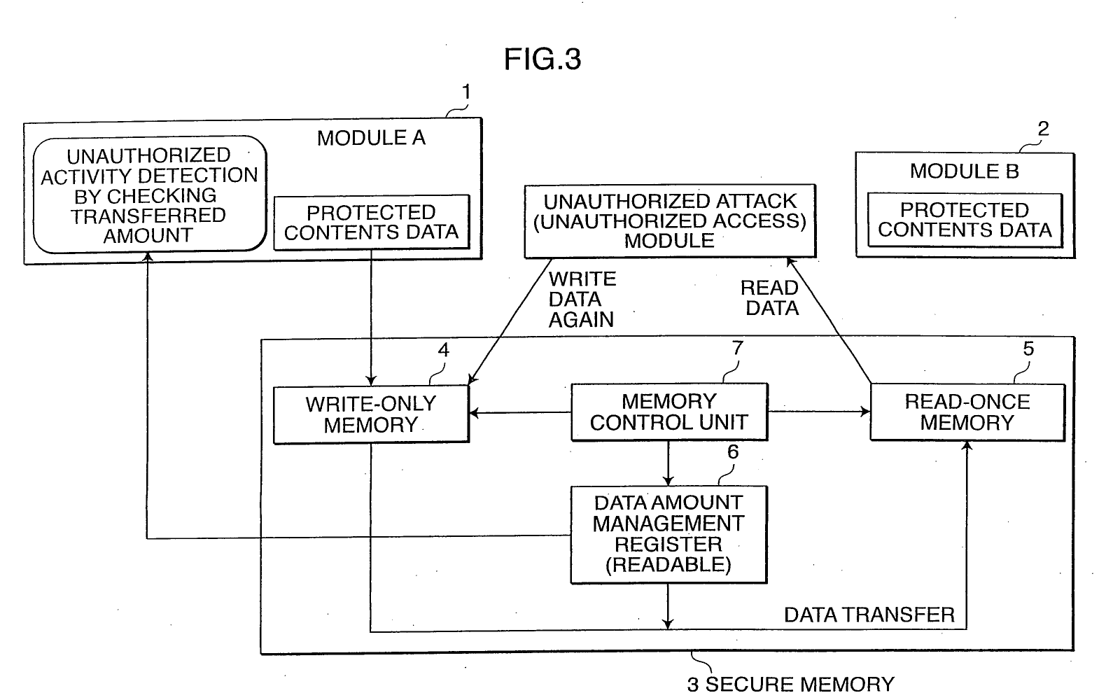

In addition, even if there is the unauthorized attack (access) such as the one shown in FIG. 3, the unauthorized attack can be detected.

In FIG. 3, suppose that the unauthorized access module reads data D11 from the read-once memory 5 and then writes the data D11 into the write-only memory 4 again. If the module B reads the data D11 that is written again, it looks as if a read is properly performed by the module B without the unauthorized access module being involved.

In this case, however, since the data D11 is written into the write-only memory 4 twice, transfer of the data D11 from the write-only memory 4 to the read-once memory 5 is also performed twice.

Since the amount of data to be stored in the data amount management register 6 is a cumulative value, an amount of the data D11 is added twice. That is, a numerical value stored in the register 6 is greater than a data cumulative value to be obtained when the data D11 is properly transferred only once.

Hence, the module A reads a value of the data amount management register 6 before writing data D11 which is of the first bock. During a period of time after the data D11 is written and before subsequent block data D12 is written, a value of the register 6 is read again. The module A compares an amount D2 of data transferred via the secure memory 3, which is a difference between the values of the register 6, with an actual amount D1 of data D11 written by the module A itself and if the amount D2 does not match the amount D1, it can be determined that there is the unauthorized access. As described above, when data D11 is written twice, if it is detected that an amount D2 of data transferred via the secure memory 3, which is obtained from a value read from the data amount management register 6 is greater than an amount D1 of data that is actually written by the module A, it is determined that there is the unauthorized access.

When it is thus determined that there is the unauthorized access, the module A does not perform a subsequent data-writing.

Two examples of the unauthorized access are described above. When data is transferred from the module A to the module B, the unauthorized access can be prevented without performing complex processes, such as encryption and decryption, that are conventionally performed.

In addition, since processes, such as encryption and decryption, that are complex and require a heavy CPU processing load do not need to be performed and only a data transfer process and a process that can be performed in a relatively short period of time, such as comparing an amount of data transferred via the secure memory unit 3 with an amount of data that is actually written into the secure memory 3, are performed, an increase in the speed of data transfer between the modules and a reduction in CPU processing load can be achieved. The secure memory 3 only needs to count an amount of data and store a count value in the register 6 and thus does not require large logic.

Although FIG. 1 shows the configuration in which two memories, i.e., the write-only memory 4 and the read-once memory 5, are provided in the secure memory 3, the present invention is not limited thereto.

For example, after data is written once into a single memory M, control may be performed by a memory control unit such that the memory M can be read only once from an external module. Then, a register is provided that counts, when a write access is made, an amount of the written data and control may be performed such that contents of the register can be read from the module.

That is, a device having one memory and one register may be provided that further includes a control module capable of performing read-once control on the memory and counting an amount of data by the register.

As described above, in the present invention, the secure memory 3 is provided, restrictions are imposed on an access to the memories (4 and 5), and furthermore, an amount of data transferred via the secure memory 3 is checked. Thus, when data is transferred between modules, without performing complex processes such as encryption and hashing processes, peeking or tampering of the data can be detected, making it possible to prevent the unauthorized access after the detection.

By stopping, immediately after the unauthorized access is detected, a subsequent data transfer process, subsequent block data can be prevented from illegally leaking.

Since upon data transfer there is no need to perform processes with a long processing time and a large workload, such as encryption, even when a large amount of data is transferred, the load on a CPU can be reduced.

In addition, since there is no need to exchange encryption keys between modules, a data transfer protocol between the modules is reduced and the overall processing time necessary for data transfer that includes session establishment can be reduced.

(Description of Configuration of Information Processing Apparatus of the Invention)

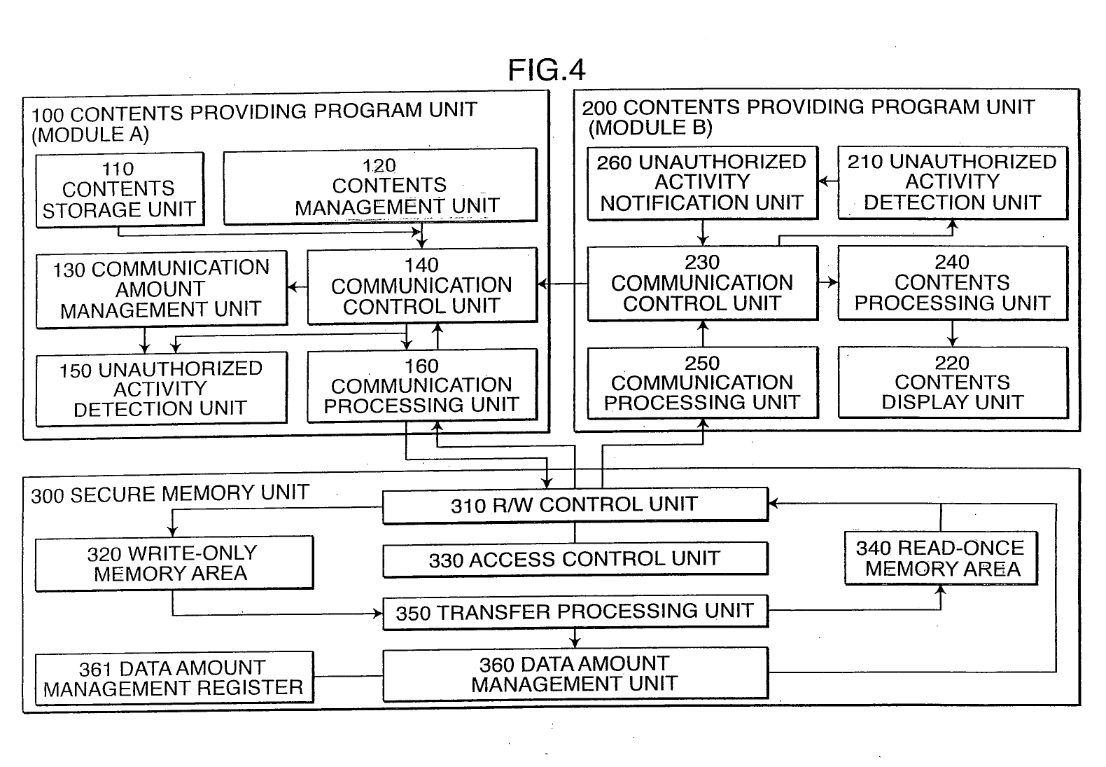

FIG. 4 is a configuration block diagram of an information processing apparatus implementing data transfer functionality and data protection functionality according to the one embodiment of the present invention.

In FIG. 4, the information processing apparatus mainly includes a contents providing program unit (corresponding to the module A) 100, a contents display program unit (corresponding to the module B) 200, and a secure memory unit 300.

The contents providing program unit 100 includes a contents storage unit 110 that stores all obtained contents; a contents management unit 120; a communication amount management unit 130 that manages the amount of communication data upon transferring block data of contents; a communication control unit 140 that controls data communication between the modules; an unauthorized activity detection unit 150 that detects presence of the unauthorized access; and a communication processing unit 160 that performs data transfer (data write and read) with the secure memory unit 300.

The contents display program unit 200 includes an unauthorized activity detection unit 210 that detects presence of the unauthorized access; a contents display unit 220 that displays contents transferred; a communication control unit 230 that controls communication between the modules; a communication processing unit 250 that performs a data read process on the secure memory unit 300; a contents processing unit 240 that combines a plurality of transferred block data units to generate (reconstruct) one set of contents; and an unauthorized activity notification unit 260 that notifies the module A that there is the unauthorized access.

The secure memory unit 300 includes a recording block composed of a write-only memory area 320, a read-once memory area 340, a data amount management register 361, and an access control unit 330 that manages an access control flag 341; and a control block composed of a read/write (R/W) control unit 310, a transfer processing unit 350 that performs data transfer from the write-only memory area 320 to the read-once memory area 340; and a data amount management unit 360 that performs a writing into and a reading from the data amount management register 361.

For the recording block, a single RAM or non-volatile memory element can be used; alternatively, different memory elements may be used for the memory regions, register, and flag, respectively.

The control block is composed of a microcomputer having a CPU, a ROM, a RAM, an I/O controller, a timer, and the like, and software that implements each functionality. That is, the secure memory unit 300 is not just a memory but is a storage element including the CPU and the like, and having data protection functionality.

The read-once memory area 340 is controlled such that the read-once memory area 340 can be read from an external module only once when data is written into the read-once memory area 340 by the transfer processing unit 350.

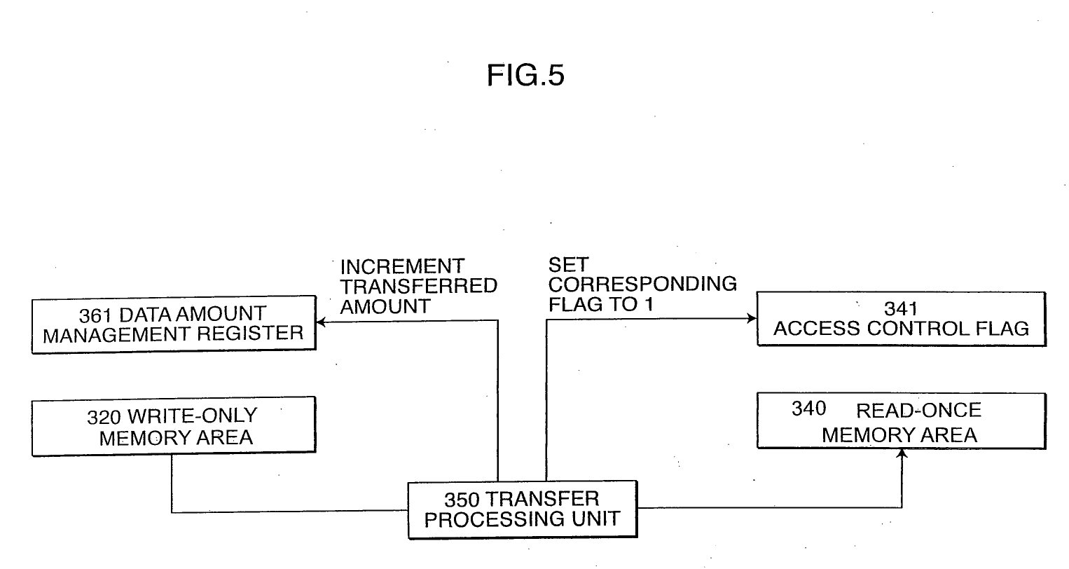

FIG. 5 is an illustrative diagram showing a relationship between the recording block and the transfer processing unit 350 of the secure memory unit 300.

The data amount management register 361 stores a cumulative value of amounts of data transferred via the secure memory unit 300. The transfer processing unit 350 adds, when reading data in a predetermined write unit from the write-only memory area 320 and writing the data into the read-once memory area 340, an amount of data corresponding to the data in the write unit, to the data amount management register 361.

The access control flag 341 is set to 1 each time a predetermined amount of block data is transferred to the read-once memory area 340, so as to indicate whether the transfer of the block data is completed.

There is a one-to-one correspondence between regions of the write-only memory area 320 and regions of the read-once memory area 340. When a write access is made from the software module A to a region of the write-only memory area 320, the transfer processing unit 350 of the secure memory unit 300 copies contents written into the region of the write-only memory area 320 to a corresponding region of the read-once memory area 340.

At the same time, the transfer processing unit 350 increments an amount of the transferred data and updates the data amount management register 361. The data amount management register 361 is initialized to zero upon reset. After reset, the data amount management register 361 holds a cumulative value of amounts of data transferred to the read-once memory area 340 from the write-only memory area 320.

The transfer processing unit 350 sets a portion of the access control flag 341 corresponding to a memory address to which the data is transferred, to 1. The access to the read-once memory area 340 is managed by the access control flag 341.

After data is read once from the read-once memory area 340, the access control unit 330 disables a reading until data is transferred to the read-once memory area 340 from the write-only memory area 320.

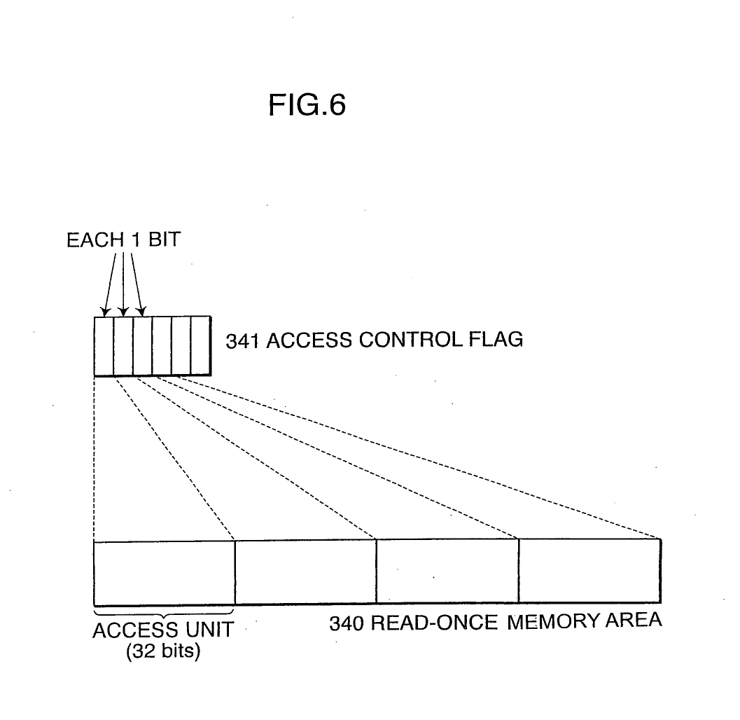

FIG. 6 is an illustrative diagram showing a correspondence between the access control flag 341 and the read-once memory area 340. The access control flag 341 holds 1-bit information for each access unit of the read-once memory area 340. For example, if the secure memory unit 300 allows only the access in a 32-bit unit, a 1-bit access control flag 341 is assigned to each 32-bit portion of the read-once memory area 340.

When the flag 341 is “0”, a memory read request from the module is not allowed (i.e., read enable is not asserted). When the flag 341 is “1”, it means that a memory read request from the module is accepted.

(Read Process on Read-Once Memory Area)

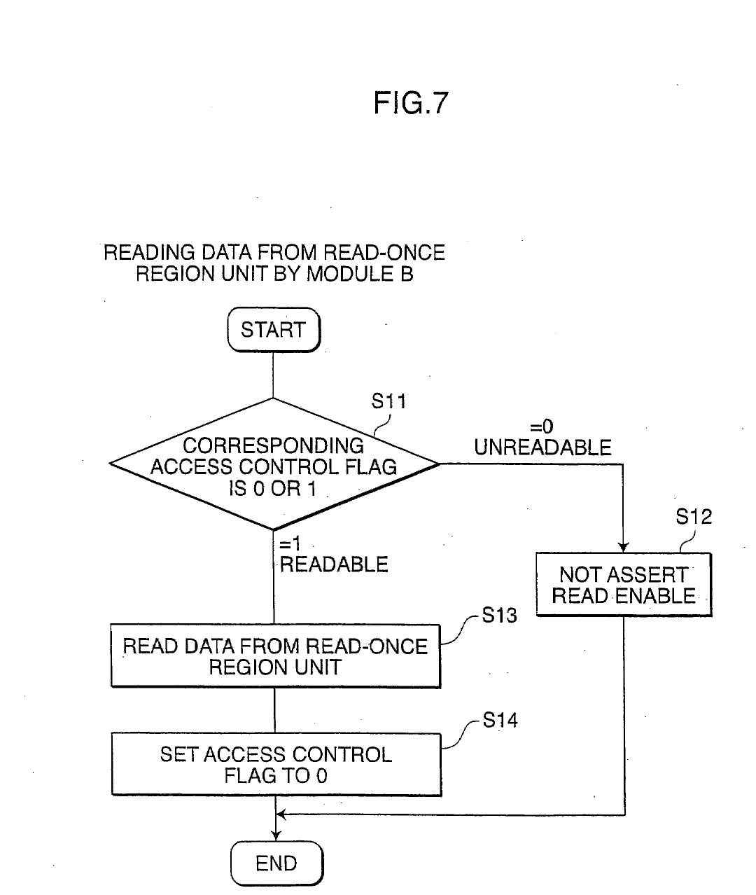

FIG. 7 is a flowchart showing a case where the module B performs a read process on the read-once memory area 340 of the secure memory unit 300 according to the one embodiment.

At step S11, when a read access is made from the module B, the transfer processing unit 350 checks on a portion of the access control flag 341 corresponding to an accessed region. If the portion of the access control flag 341 is 0, then a read access is denied, and thus, the process proceeds to step S12 and the secure memory unit 300 does not assert read enable to the read request and does not return a response.

On the other hand, if the portion of the access control flag 341 is 1, then the process proceeds to step S13 and in response to the read request from the module B, data stored in the read-once memory area 340 is read and the read data is provided to the module B.

At step S14, the transfer processing unit 350 sets the access control flag 341 to 0.

As shown in FIG. 7, when the access control flag 341 is 0, data read is denied and when the access control flag 341 is 1, data read is allowed. For an address at which a read access is made once, a corresponding access control flag 341 is set to 0 to disable a read. By this method, read-once functionality can be implemented that does not allow once read data to be read again from the external module B.

(Write Process on Write-Only Memory Area)

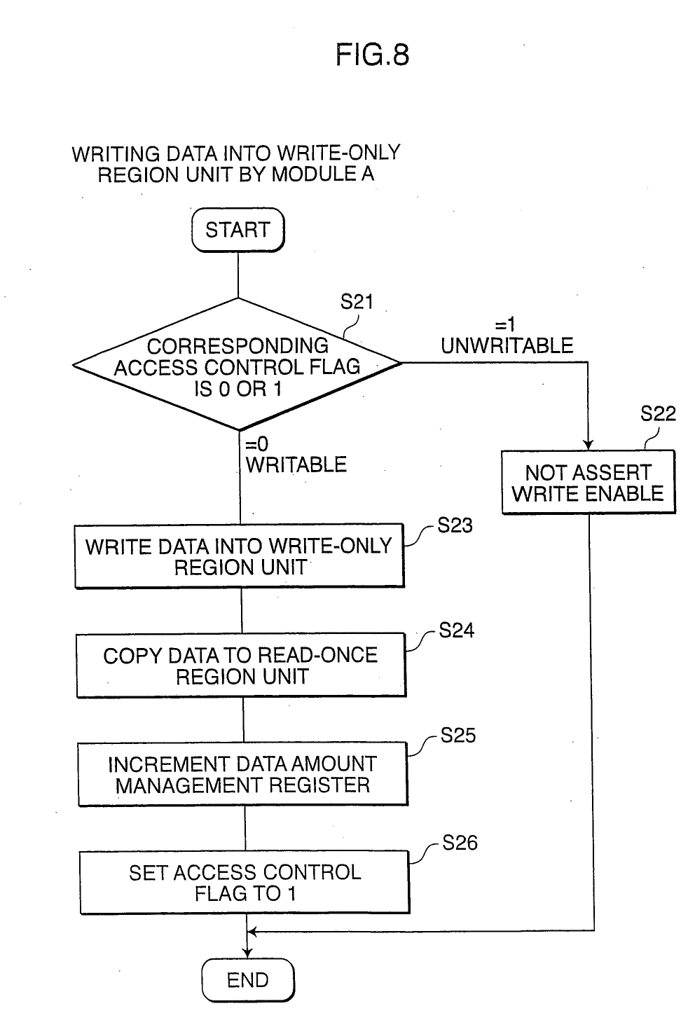

FIG. 8 is a flowchart showing a case where the module A writes the data into the write-only memory area 320 according to the one embodiment.

At step S21, when a write access is made from the module A, the transfer processing unit 350 checks on a portion of the access control flag 341 corresponding to the accessed region. If the portion of the access control flag 341 is 1, then the process proceeds to step S22. Namely, when data that has not yet been read remains, the process ends without enabling the writing.

On the other hand, if the portion of the access control flag 341 is 0, then the process proceeds to step S23 and the writing is enabled and data provided from the module A is written into the write-only memory area 320.

Although, in this example, when data in the read-once memory area 340 has not yet been read, overwriting of the read-once memory area 340 is not allowed, it is also possible to implement such that a data-writing is allowed regardless of the value of the access control flag 341.

After the writing is performed, the written data is copied to the read-once memory area 340 (step S24) and the data amount management register 361 is incremented by an amount corresponding to the amount of the copied data (step S25). Finally, at step S26, a corresponding portion of the access control flag 341 is set to 1 so that the data can be read.

(Description of Processing Contents by Transfer Processing Unit)

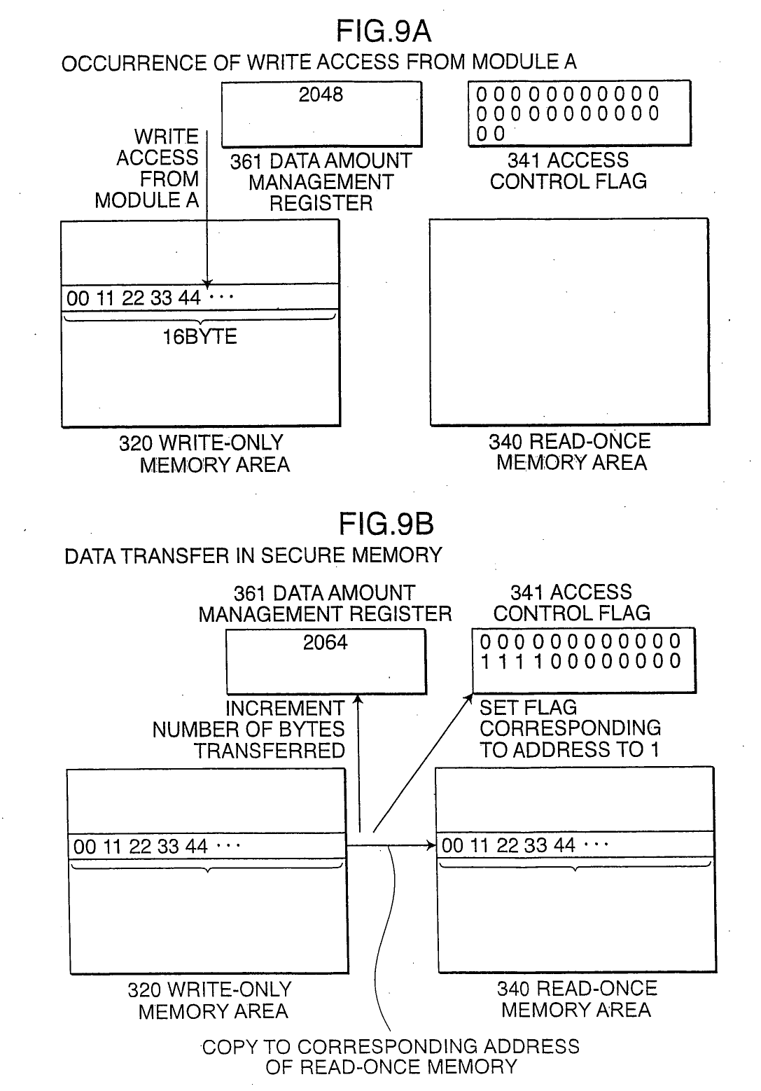

FIG. 9 is an illustrative diagram of specific processing contents by the transfer processing unit 350 of the secure memory unit 300 according to the one embodiment.

In FIG. 9A, it is assumed that the current value held by the data amount management register 361 is 2048 and all portions of the access control flag 341 are 0. Here, suppose that the module A performs a 16-byte writing on the write-only memory area 320 of the secure memory unit 300.

The transfer processing unit 350 uses the writing as a trigger and copies, as shown in FIG. 9B, the written 16-byte data to a corresponding region of the read-once memory area 340. At the same time, the transfer processing unit 350 increments the value of the data amount management register 361 by an amount corresponding to the number of bytes of the transferred data. In this case, 16 is added to the initial value of 2048, resulting in 2064. A portion of the access control flag 341 corresponding to the region where the transfer has been performed is set to 1. By this, it becomes possible for the module B to read only once an updated region of the read-once memory area 340.

(Description of Contents Providing Program Unit (Module A))

As shown in FIG. 4, the contents providing program unit (module A) 100 includes the contents storage unit 110, the contents management unit 120, the communication amount management unit 130, the communication control unit 140, the unauthorized activity detection unit 150, and the communication processing unit 160.

The contents storage unit 110 stores contents including music data, moving image data, and other streaming data.

The contents management unit 120 stores management information associated with the contents stored in the contents storage unit 110, e.g., information about copy control of accumulated contents. The copy control information includes information on from which byte to which byte of contents can or cannot be passed to what module. For example, information reads: since contents are copy-once contents, if the contents are once written to a removable medium, such as a DVD, “the contents cannot be passed to a DVD move module”.

The communication amount management unit 130 obtains from the communication control unit 140 an amount of data (amount of communication) of block contents transmitted to the secure memory unit 300 through the communication control unit 140 and the communication processing unit 160, and manages the amount of data.

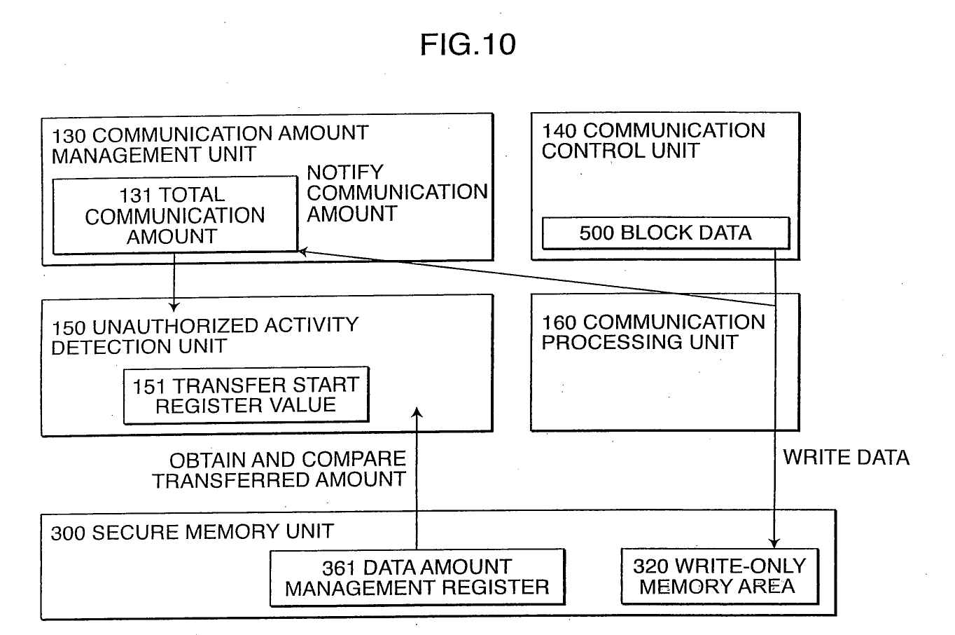

FIG. 10 is an illustrative diagram showing management information used for the data transfer according to the one embodiment.

To transfer contents between the modules (A and B), first, a session needs to be established. Upon starting the session, the unauthorized activity detection unit 150 of the module A obtains from the data amount management register 361 a cumulative amount of data written into the secure memory unit 300 and stores the cumulative amount of data as a transfer start register value 151.

The communication amount management unit 130 stores a total amount 131 of communication that is performed during the session. When block data 500 is actually written into the secure memory unit 300 from the contents providing program unit 100 (module A), the communication control unit 140 writes the block data 500 into the write-only memory area 320 of the secure memory unit 300 through the communication processing unit 160 and provides an amount of data written into the communication amount management unit 130. Then, the communication control unit 140 adds the amount of data to the total amount of communication 131.

In addition, the communication control unit 140 transfers, based on management information stored in the contents management unit 120, contents stored in the contents storage unit 110 to the contents display program unit 200 through the secure memory unit 300.

(One Embodiment of Process by Contents Providing Program Unit (Module A))

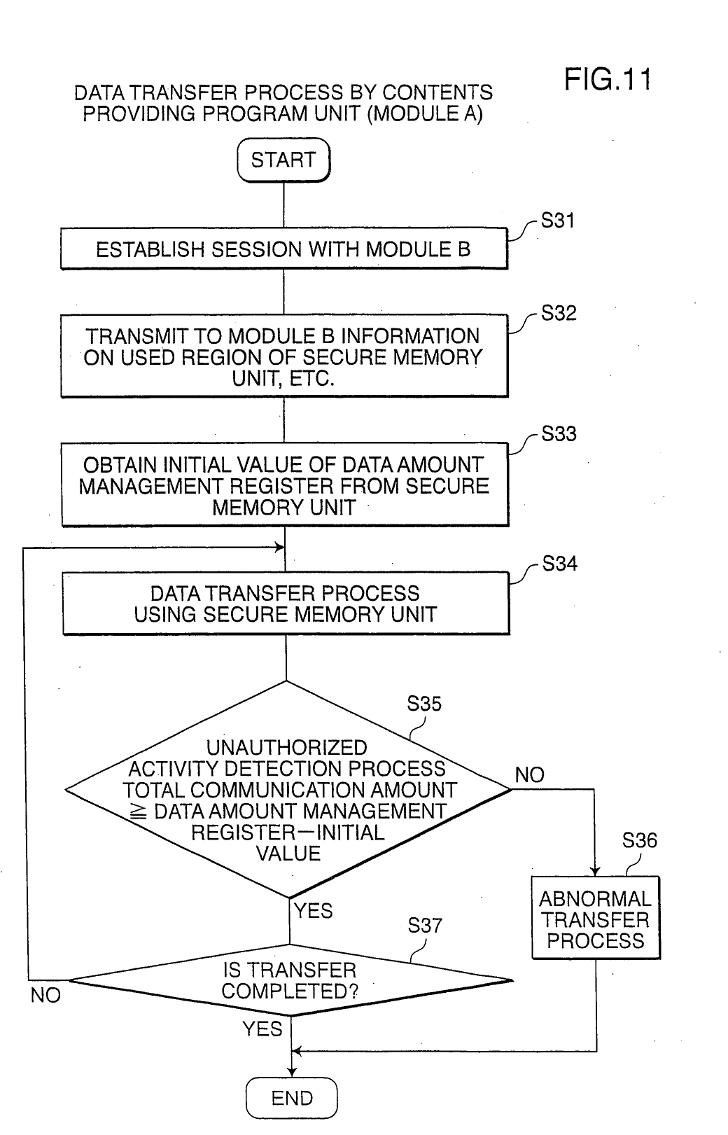

FIG. 11 is a flowchart showing the contents providing program unit (module A) according to the one embodiment.

First, at step S31, by the communication control unit 140 and the communication control unit 230 of the contents display program unit (module B), a session is established to perform data transfer. For the session establishment, a method used for general secret communication, such as a PKI, can be used.

After the session is established, at step S32, the contents providing program unit 100 (module A) encrypts and transmits information indicating that data communication is performed through the secure memory unit 300, an address of the secure memory unit 300 to be used, and information on a region of the read-once memory area 340 to be used, to the contents display program unit 200 (module B).

At step S33, the contents providing program unit 100 (module A) obtains from the secure memory unit 300 an initial value (TO) of the data amount management register 361 present upon start of transfer and starts use of the write-only memory area 320. Thereafter, at steps S34 to S37, a data transfer process (step S34) and an unauthorized activity detection process (step S35) are repeated until transfer of data on the entire contents is completed.

A specific example of the unauthorized activity detection process (step S35) performed by the unauthorized activity detection unit 150 during a data transfer process will be described below.

The communication control unit 140 notifies the communication amount management unit 130 an amount of data (amount of communication) on contents written into the secure memory unit 300 through the communication processing unit 160. In addition, the communication control unit 140 notifies the unauthorized activity detection unit 150 a cumulative value T1 of amounts of data transferred via the secure memory unit 300, which is obtained from the data amount management register 361 through the R/W control unit 310 of the secure memory unit 300, and requests the unauthorized activity detection unit 150 to determine whether there is the unauthorized access to the secure memory unit 300.

If the communication control unit 140 is notified by the unauthorized activity detection unit 150 that there is the unauthorized access or if the communication control unit 140 receives from the communication control unit 230 of the contents display program unit 200 (module B) an instruction to stop transfer, then the communication control unit 140 terminates the process of transmitting contents to the contents display program unit 200 (module B). Furthermore, the communication control unit 140 may notify the communication processing unit 160 to discard data on contents being transmitted.

The unauthorized activity detection unit 150 obtains a cumulative value T1 of amounts of data transferred via the secure memory unit 300, in response to a request from the communication control unit 140 or upon the arrival of predetermined regular timing, and compares a total amount TA of communication obtained from the communication amount management unit 130 with the amount T1 of transfer. If, taking into account the initial value T0, the total amount TA does not match the amount T1, then the unauthorized activity detection unit 150 determines that there is the unauthorized access.

For example, each time the communication control unit 140 performs a write into the secure memory unit 300 and provides notification to the communication amount management unit 130, the unauthorized activity detection unit 150 reads a value T1 of the data amount management register 361 and compares the value T1 with a total amount 131 (TA) of communication.

Here, the unauthorized activity detection unit 150 checks whether a predetermined relationship is established among the total amount 131 (TA) of communication, the transfer start initial register value 151 (T0), and the value (T1) of the data amount management register 361 of the secure memory unit 300.

Specifically, the unauthorized activity detection unit 150 checks at step S35 whether an expression such that the total amount (TA) of communication≧the data amount management register value (T1)−the initial value (T0) is satisfied.

Here, taking into account a case where a transfer process is not yet performed in the secure memory unit 300, the unauthorized activity detection unit 150 may check whether a relationship such that the total amount 131 (TA) of communication+the transfer start initial register value 151 (T0)−secure memory capacity≦the data amount management register 361 (T1)≦the total amount 131 (TA) of communication+the transfer start initial register value 151 (T0) is satisfied.

Alternatively, the unauthorized activity detection unit 150 may detect by an interrupt or the like an actual completion of transfer in the secure memory unit 300, read at timing of the detection a value of the data amount management register 361, and then check whether an expression such that the total amount 131 (TA) of communication+the transfer start initial register value 151 (T0)=the data amount management register 361 (T1) is satisfied.

When any of the above-described conditional expressions is satisfied, it can be determined that an unauthorized activity that “data is written into the secure memory unit 300 by one other than the contents providing program unit 100” is not performed. Hence, if a result of the determination satisfies the condition, it is determined that there is no unauthorized access and the determination result is notified to the communication control unit 140.

In response to an instruction from the communication control unit 140, the communication processing unit 160 writes subsequent contents block into the write-only memory area 320 of the secure memory unit 300. In addition, in response to an instruction from the communication control unit 140, the communication processing unit 160 obtains from the data amount management register 361 of the secure memory unit 300 a cumulative value (T1) of amounts of data transferred via the secure memory unit 300 and notifies the obtained cumulative value (T1) to the communication control unit 140.

By repeating, while performing such unauthorized activity detection, a data write and an unauthorized activity detection process until communication is completed, normal data transfer is implemented.

Note that if the condition is not satisfied at step S35, then it is determined that there is the unauthorized access and thus the process proceeds to step S36 and an abnormal transfer process is performed. In the abnormal transfer process, for example, a subsequent data transfer request is not accepted or the fact that there is the unauthorized access is displayed.

(Description of Process by Contents Display Program Unit (Module B) )

As shown in FIG. 4, the contents display program unit (module B) 200 includes the unauthorized activity detection unit 210, the contents display unit 220, the communication control unit 230, the contents processing unit 240, and the communication processing unit 250.

In response to a request from the communication control unit 230 or upon the arrival of predetermined timing, the unauthorized activity detection unit 210 determines whether there is the unauthorized access to the secure memory unit 300, based on read data obtained from the communication control unit 230 and notifies a determination result to the communication control unit 230 and the unauthorized activity notification unit 260.

The contents display unit 220 displays contents transferred from the contents providing program unit (module A) 100 through the secure memory unit 300, in response to an instruction from the contents processing unit 240.

The communication control unit 230 obtains from the communication processing unit 250 block data transferred from the contents providing program unit (module A) 100 through the secure memory unit 300 and notifies the contents processing unit 240 of the block data. In response to the notification from the communication control unit 230, the contents processing unit 240 processes the transferred block data to reconstruct contents and notifies the contents display unit 220 of display of the contents.

In addition, the communication control unit 230 notifies the unauthorized activity detection unit 210 of the block data on contents that is read through the communication processing unit 250 and requests the unauthorized activity detection unit 210 to determine whether there is the unauthorized access to the secure memory unit 300. Thereafter, if the communication control unit 230 is notified by the unauthorized activity detection unit 210 that there is the unauthorized access, then the communication control unit 230 notifies the communication control unit 140 of the contents providing program unit (module A) 100 of termination of a contents transmission process. The unauthorized activity notification unit 260 notifies the module A that there is an unauthorized activity.

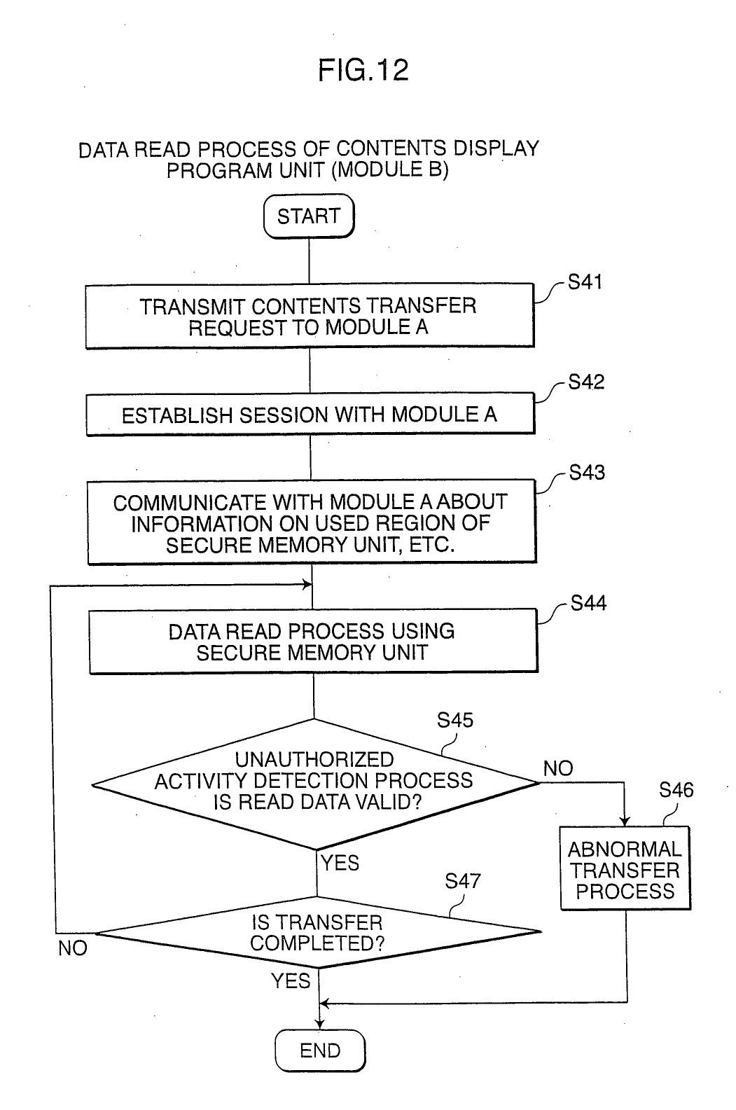

FIG. 12 is a flowchart of the contents display program unit (module B) 200 according to the one embodiment.

At step S41, upon start of transfer, a contents transfer request is transmitted to the contents providing program unit (module A) 100. At step S42, a session is established using a PKI or the like.

After the session is established, at step S43, information, such as information on a region of the secure memory unit 300 to be used, is encrypted and the encrypted information is received from the module A.

At step S44, block data written by the module A into the write-only memory area 320 of the secure memory unit 300 is read from the read-once memory area 340.

At step S45, each time data is read, an unauthorized activity detection process is performed. If an unauthorized activity is detected during an unauthorized activity detection process, then it is determined that there is the unauthorized access and thus an abnormal transfer process is performed (step S46).

On the other hand, if an unauthorized activity is not detected, then processes from steps S44 to S47 are repeated until transfer of block data on all contents is completed. When an unauthorized activity is not detected, while the module B sequentially reads block data on the contents, the module B displays the block data.

In the unauthorized activity detection process at step S45, if, for example, read data is all zeros, then it is determined that normal data has not been able to be read from the read-once memory area 340, i.e., a module other than the module B has read data from the read-once memory area 340, and thus, it is determined that there is an unauthorized activity. Alternatively, if a field in data that should essentially hold some value is zero, too, it is determined that there is an unauthorized activity.

In addition to the above cases, if a situation where the unauthorized access is definitely present can be detected, then it is determined that there is the unauthorized access. For example, when target data is MPEG-TS, in MPEG-TS data, if data is proper, byte data of 0x47 appears every 188 bytes as a TS header. However, in a case where unauthorized data is definitely present, such as a case where zero is stored in a location where 0x47 should be stored or a case where a payload of video data is zero, it is determined that there is the unauthorized access. Alternatively, an unauthorized activity may be detected by detecting a situation where, though a sufficient period of time for the module A to definitely perform a data write into the secure memory unit 300 has elapsed, the read-once memory area 340 does not go into a read enable state.

(Another Embodiment of Secure Memory Unit)

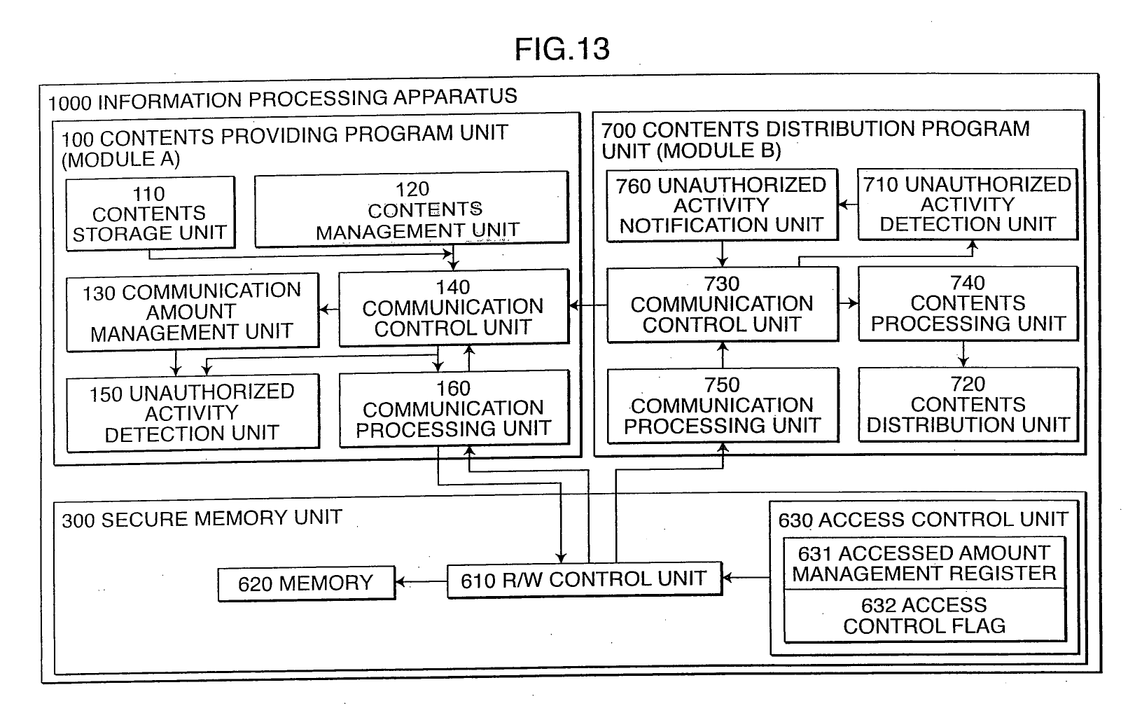

Although FIG. 4 shows the configuration in which data is transferred between two memories (320 and 340) in the secure memory unit 300, here, a case will be described where a memory to be written to by the module A and a memory to be read from by the module B are a same single memory 620, as shown in FIG. 13. In this case, in place of the data amount management register 361, an accessed amount management register 631 capable of managing the amount of a write access made by the module A is provided to provide read-once functionality that does not allow, after the module B has made a read access once, a read until subsequent block data is written.

FIG. 13 shows a configuration block diagram of the information processing apparatus using such a secure memory according to the one embodiment.

In FIG. 13, a secure memory unit 300 is composed of a R/W control unit 610, the memory 620, and an access control unit 630.

The access control unit 630 includes the accessed amount management register 631 and an access control flag 632. The module B is a contents distribution program unit 700 and includes a contents distribution unit 720 that distributes contents. Other blocks of the module B are the same as those of the module B of FIG. 4.

When a write access is made to the secure memory unit 300 from the module A, the R/W control unit 610 writes written data into the memory 620 and notifies the access control unit 630 that there is a write access. As with the process of the data amount management register in FIG. 4, the access control unit 630 increments the number of data written into the accessed amount management register 631 and sets a portion of the access control flag 632 corresponding to an address to which the data is written, to 1.

When a read access is made to the secure memory unit 300 from the module B, if the read access is made to an address whose corresponding portion of the access control flag 632 is set to 1, then the read is allowed. If the corresponding portion of the access control flag 632 is set to 0, then control is performed not to allow the read. By this, read-once functionality can be implemented.

As with the embodiment of FIG. 4, when the unauthorized access module reads data, the contents distribution program unit 700 (module B) can detect an unauthorized activity. When the same data is written into the secure memory unit 300 again, by the module A checking a numerical value of the accessed amount management register 631, an unauthorized activity can be detected.

The contents distribution program unit 700 (module B) having received data performs network distribution of received contents. In this case, the contents distribution program unit 700 (module B) performs encryption that supports a data protection protocol in a network, such as a DTCP, on the received data and then distributes the encrypted data.

An authentication management unit may be provided to the module A so that whether valid data transfer is performed between the two modules can be detected by a response from the module B.

For example, during data transfer, a response indicating that the module B is receiving data is written into the write-only memory area 320 of the secure memory unit 300.

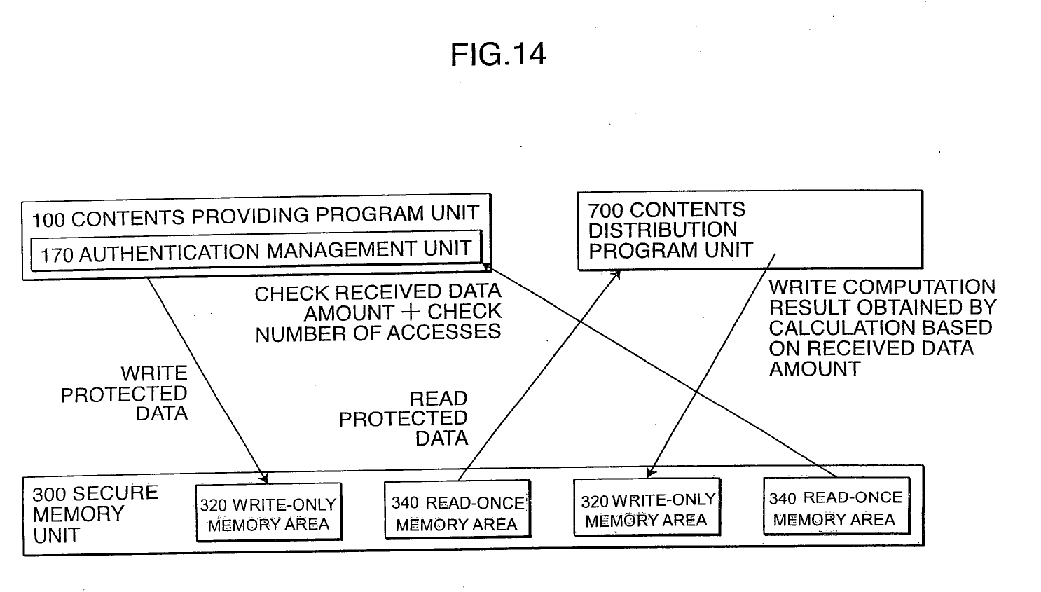

FIG. 14 is an illustrative diagram of determination of the validity of the data transfer by checking a response according to the one embodiment. In FIG. 14, as with the above-described embodiment, the contents providing program unit 100 (module A) writes block data into a write region 320 of the secure memory unit 300 and transfers the data to the contents distribution program unit 700 (module B) through a read region 340.

On the other hand, the contents distribution program unit 700 (module B) writes an amount (response) of the received block data into a response writing region (write-only region 320) of the secure memory unit 300. Thereafter, an authentication management unit 170 of the contents providing program unit 100 (module A) checks, from the secure memory unit 300, contents of the response from the contents distribution program unit 700 and the number of accesses to the response writing region. That is, the authentication management unit 170 checks whether the response (amount of data) returned from the module B matches the amount of data transferred from the contents providing program unit 100 (module A) and whether the number of accesses is valid. If the amount of data written into the secure memory unit 300 by the module A matches the responded amount of data and there is no problem in the number of accesses, then it is determined that valid data transfer is performed.

(Verification of Validity of Secure Memory Unit)

In the present invention, the contents providing program unit 100 and the contents display program unit 200 need to certainly access the valid secure memory unit 300.

However, a method may be considered in which, for example, an unauthorized activity is performed at the OS or driver level of the information processing apparatus, module software is modified to return a general memory region that can be accessed by anybody, in response to a request to use the secure memory unit 300 from the contents providing program unit 100 (module A), and block data on contents written into the memory region is stolen. In this case, the unauthorized access is made without the secure memory unit 300 being involved.

For a method of preventing such an unauthorized activity, it is considered to provide memory expansion functionality (program expansion monitoring unit 190) of the contents providing program unit 100 (module A) itself to the secure memory unit 300.

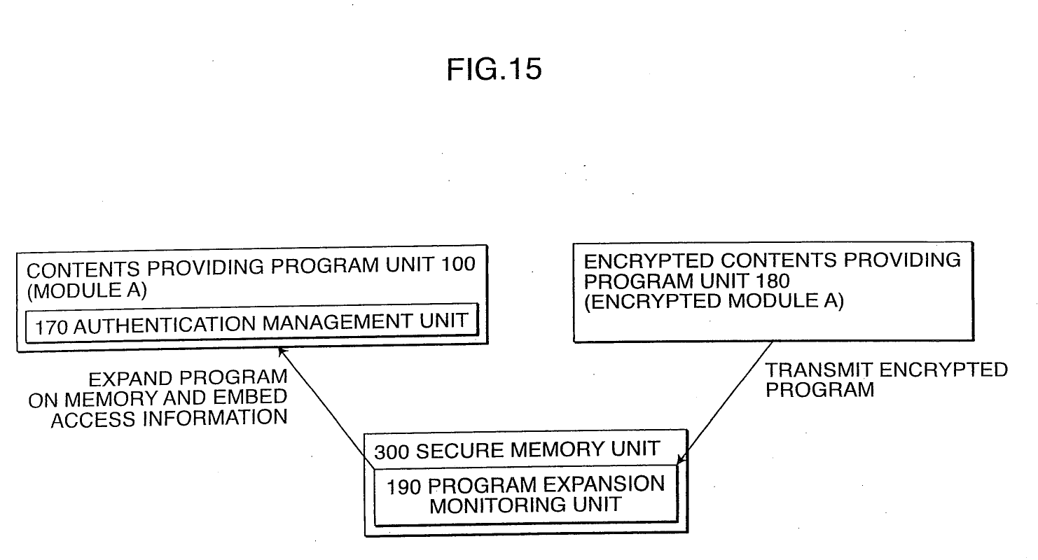

FIG. 15 is an illustrative diagram of a verification process of the validity of the secure memory according to the one embodiment.

As shown in FIG. 15, an authentication management unit 170 that stores an authentication key (access information) is provided in the contents providing program unit 100 (module A). In an initial state, the contents providing program unit 100 (module A) itself is encrypted as encrypted module data (encrypted module A) by using an encryption key held by the secure memory unit 300 and the encrypted contents providing program unit is stored on a hard disk.

Upon execution of a program of the module A, the program expansion monitoring unit 190 of the secure memory unit 300 decrypts the encrypted module A (180) and expands the decrypted module A on the hard disk. Upon expansion of the contents providing program unit (module A), the secure memory unit 300 rewrites an embedded key of the module A with a random number value and stores the value of the rewritten embedded key in the secure memory unit 300.

The expanded contents providing program unit 100 (module A) provides, upon starting an actual transfer process, a random number value to the secure memory unit 300. The secure memory unit 300 performs a predetermined computation (e.g., XOR computation) by using the random number value and the embedded key which are provided by the module A and returns a result of the computation to the module A. Then, the authentication management unit 170 of the contents providing program unit 100 (module A) checks whether a result of a computation performed using the embedded key owned thereby and the random number value matches the computation result returned from the secure memory unit 300.

If the results match, then it can be determined that the contents providing program unit 100 (module A) is accessing a valid secure memory. In an initial state, the contents providing program unit 100 (module A) is encrypted and thus is difficult to be tampered. Furthermore, since an embedded key can be changed each time a module program is executed, it is difficult for the unauthorized access module to realize an operation equivalent to the verification process, making it possible to more surely prevent the unauthorized access.

According to the present invention, since there is no need to perform complex and time-consuming processes, such as encryption and decryption processes, to prevent data from leaking by the unauthorized access, the load of processing for data protection can be suppressed while sufficient security is ensured. That is, when data is transferred between two modules, the time and load necessary for processing which is performed to ensure the security of the transferred data can be reduced.

What is claimed is:

1. A storage element having data protection functionality for receiving a data-writing and a data-reading from a functional module, the storage element comprising:
a storage unit that has a memory region with a predetermined capacity for storing the data and stores the data written by the functional module;
a data amount management register that stores an amount of the data written by the functional module so as to be readable from the functional module; and
a control unit that controls, when the data stored in the storage unit is read by the functional module, to disable a data-reading from a portion of the memory region of the storage unit where data corresponding to the read data is stored, until a data-writing is performed by the functional module.

2. The storage element according to claim 1, further comprising an access control flag for allowing or denying an access from the functional module, wherein
when the access control flag is in a first state, the control unit allows a writing into the storage unit from the functional module and denies a reading from the storage unit by the functional module, and
when the access control flag is in a second state, the control unit denies a writing into the storage unit from the functional module and allows a reading from the storage unit by the functional module, and
after the data is written by the functional module, the control unit denies a writing into the storage unit from the functional module by setting the access control flag to the second state, and
when there is a reading request from the functional module with the access control flag being in the second state, the control unit allows a reading from the storage unit by the functional module and denies a reading from the storage unit by the functional module by setting, after the reading is performed, the access control flag to the first state.

3. A storage element for receiving a data-writing and a data-reading from a functional module, the storage element comprising,
a storage unit including a write-only memory region that has a memory region with a predetermined capacity for storing the data, stores the data written by the functional module, and allows only a writing of the data and a read-only memory region that allows only a reading of the data;
a transfer processing unit that transfers the data written into the write-only memory region to the read-only memory region;
an access control unit that disables a reading from a portion of the read-only memory region where the data read once is stored, until the data is transferred to the read-only memory region from the write-only memory region; and
a data amount management register that stores, as an amount of data written by the functional module, an amount of the data transferred by the transfer processing unit so as to be readable from the functional module.

4. The storage element according to claim 3, further comprising an access control flag for allowing or denying an access from the functional module, wherein
when the access control flag is in a first state, the access control unit allows a writing into the write-only memory region and denies a reading from the read-only memory region, and
when the access control flag is in a second state, the access control unit denies a writing into the write-only memory region and allows a reading from the read-only memory region, and
after the data is written by the functional module, the access control unit denies a writing into the write-only memory region by setting the access control flag to the second state.

5. The storage element according to claim 4, wherein
when there is a read request from the functional module with the access control flag being in the second state, a reading from the read-only memory region is allowed, and
after the reading is performed, by setting the access control flag to the first state, a reading from the read-only memory region is denied.

6. The storage element according to claim 4, wherein
when there is a read request from the functional module with the access control flag being in the first state, the data being read-request is replaced with pattern data never appearing in the written data and the pattern data is read by the functional module.

7. The storage element according to claim 6, wherein the pattern data is all-zero data.

8. The storage element according to any one of claims 4, 5, 6, and 7, wherein the access control flag is set to 0 in the first state and is set to 1 in the second state.

9. An information processing apparatus comprising
the storage element according to any one of claims 1 and 2,
a first functional module that writes data into the storage element, and
a second functional module that reads the data from the storage element, wherein
after the first functional module writes contents data into the storage unit of the storage element, the storage element controls such that the written contents data can be read, and the second functional module reads the contents data stored in the storage unit.

10. An information processing apparatus comprising:
the storage element according to any one of claims 3 to 7;
a first functional module that writes data into the storage element; and
a second functional module that reads the data from the storage element, wherein
after the first functional module writes contents data into the write-only memory region of the storage element, the storage element transfers the written contents data to the read-only memory region of the storage element, and the second functional modules reads the contents data transferred to the read-only memory region.

11. The information processing apparatus according to claim 10, wherein
the first functional module includes: a communication amount management unit that manages an amount (D1) of the data written into the storage element; and an unauthorized activity detection unit that detects an unauthorized access being made to the data in the storage element, and
the unauthorized activity detection unit of the first functional module obtains an amount (D2) of the data written into the storage element by reading the data amount management register of the storage element, and determines whether the unauthorized access is made to the data by comparing the amount (D1) of data managed by the communication amount management unit with the amount (D2) of data.

12. The information processing apparatus according to claim 11, wherein
when the amount (D2) of data obtained from the data amount management register of the storage element is greater than the amount (D1) of data, the unauthorized activity detection unit of the first functional module determines that there is the unauthorized access and the first functional module does not perform a subsequent data-writing into the storage element.

13. The information processing apparatus according to claim 10, wherein
the second functional module includes an unauthorized activity detection unit, and
when the unauthorized activity detection unit of the second functional module detects that the data read from the storage element is pattern data never appearing in the written data, the unauthorized activity detection unit of the second functional module determines that there is the unauthorized access.

14. The information processing apparatus according to claim 13, wherein
the second functional module includes an unauthorized activity notification unit that notifies, when the unauthorized activity detection unit of the second functional module determines that there is the unauthorized access, the first functional module that there is the unauthorized access, and
the first functional module receiving the notification does not perform a subsequent data-writing into the storage element.
